(19) United States
(12) Patent Application Publication
(10) Pub. No.: US 2026/0316648 A1
(43) Pub. Date: Oct. 15, 2026

(54) INTERMEDIATE SEAT ARMREST FOR A MOTOR VEHICLE

(71) Applicant: Ford Global Technologies, LLC, Dearborn, MI (US)

(72) Inventors: Robert Engelmann, Köln (DE); Humayun Yousofzy, Solingen (DE); Joerg Stephan, Pulheim (DE)

(73) Assignee: Ford Global Technologies, LLC, Dearborn, MI (US)

(21) Appl. No.: 19/565,692

(22) Filed: Mar. 13, 2026

(30) Foreign Application Priority Data
Apr. 9, 2025 (DE) 102025113951.2

(51) Int. Cl. B60N 2/75; B60R 7/04

(52) U.S. Cl. CPC B60N 2/793; B60N 2/77; B60R 7/04

(57) ABSTRACT

An intermediate seat armrest for a motor vehicle has at least one substantially hollow cuboidal storage compartment and a closure cover covering the hollow cuboidal storage compartment. A pivotable carrier is arranged on the hollow cuboidal storage compartment. A first pivotable closure cover part and a second pivotable closure cover part, which jointly form the entire closure cover, are arranged on the pivotable carrier.

### CROSS-REFERENCE TO RELATED APPLICATION

This application claims foreign priority benefits under 35 U.S.C. § 119(a)-(d) to German Application No. DE102025113951.2 filed Apr. 9, 2025, which is hereby incorporated by reference in its entirety.

### FIELD OF THE DISCLOSURE

The present disclosure generally relates to an intermediate seat armrest for a motor vehicle.

### BACKGROUND OF THE DISCLOSURE

An intermediate seat armrest is typically arranged between the front seats of a motor vehicle, such as for example a passenger motor vehicle, also referred to as a car. The intermediate seat armrest provides the driver of the motor vehicle with a comfortable support surface for their arm and may also provide a storage space. The seating comfort is enhanced by the support surface of the intermediate seat armrest. The surface of the intermediate seat armrest is generally designed to be upholstered.

The intermediate seat armrest generally has a closure cover arranged, for example, above a storage space which is configured as a box-shaped housing. The closure cover can be at least partially opened for removing or introducing small objects from the storage space or into the storage space.

The intermediate seat armrest typically cannot be adapted to drivers of different heights since the intermediate seat armrest does not provide for height adjustment. It is also generally not possible to maintain at least one part of the armrest function when storage space below the closure cover. It would be desirable to provide for an intermediate seat armrest for a motor vehicle which provides, in addition to a storage space, additional comfort.

### SUMMARY OF THE DISCLOSURE

According to a first aspect of the present disclosure, an intermediate seat armrest for a motor vehicle includes at least one substantially hollow cuboidal storage compartment, a closure cover covering the hollow cuboidal storage compartment and a pivotable carrier arranged on the hollow cuboidal storage compartment. A first pivotable closure cover part and a second pivotable closure cover part jointly form the entire closure cover and are arranged on the pivotable carrier.

Embodiments of the first aspect of the present disclosure can include any one or a combination of the following features:
the pivotable carrier is arranged on the hollow cuboidal storage compartment to be pivotable about a first axis of rotation;
the first pivotable closure cover part is arranged on the pivotable carrier to be pivotable about a second axis of rotation;
the second pivotable closure cover part is arranged on the pivotable carrier to be pivotable about a third axis of rotation;
a first upholstered surface may be arranged on a first upper face of the first pivotable closure cover part and on a second upper face of the second pivotable closure cover part;
a second upholstered surface may be arranged on a first lower face of the first pivotable closure cover part;
a second lower face of the second pivotable closure cover part may be configured as a tray-shaped support;
the second pivotable closure cover part has cutouts, and wherein tabs of the pivotable carrier are arranged to be engaged in the cutouts;
the first axis of rotation, the second axis of rotation and the third axis of rotation are arranged to be oriented parallel to one another;
and the first axis of rotation, the second axis of rotation and the third axis of rotation are arranged to be oriented in a direction of a transverse axis of the motor vehicle at right-angles to a direction of travel of the motor vehicle.

According to a second aspect of the present disclosure, a seat armrest for a motor vehicle includes at least one substantially hollow cuboidal storage compartment, a closure cover covering the hollow cuboidal storage compartment and a pivotable carrier arranged on the hollow cuboidal storage compartment. A first pivotable closure cover part and a second pivotable closure cover part jointly form the entire closure cover and are arranged on the pivotable carrier. The pivotable carrier is arranged on the hollow cuboidal storage compartment to be pivotable about a first axis of rotation. The first pivotable closure cover part is arranged on the pivotable carrier to be pivotable about a second axis of rotation. The second pivotable closure cover part is arranged on the pivotable carrier to be pivotable about a third axis of rotation. The first axis of rotation, the second axis of rotation and the third axis of rotation are arranged to be oriented parallel to one another.

Embodiments of the second aspect of the present disclosure can include any one or a combination of the following features:
a first upholstered surface may be arranged on a first upper face of the first pivotable closure cover part and on a second upper face of the second pivotable closure cover part;
a second upholstered surface may be arranged on a first lower face of the first pivotable closure cover part;
a second lower face of the second pivotable closure cover part may be configured as a tray-shaped support;
the second pivotable closure cover part has cutouts, and wherein tabs of the pivotable carrier are arranged to be engaged in the cutouts;
the first axis of rotation, the second axis of rotation and the third axis of rotation are arranged to be oriented in a direction of a transverse axis of the motor vehicle at right-angles to a direction of travel of the motor vehicle; and
the seat armrest is an intermediate seat armrest for use between two seats in the motor vehicle.

These and other features, advantages, and objects of the present disclosure will be further understood and appreciated by those skilled in the art by reference to the following specification, claims, and appended drawings.

### BRIEF DESCRIPTION OF THE DRAWINGS

### IN THE DRAWINGS

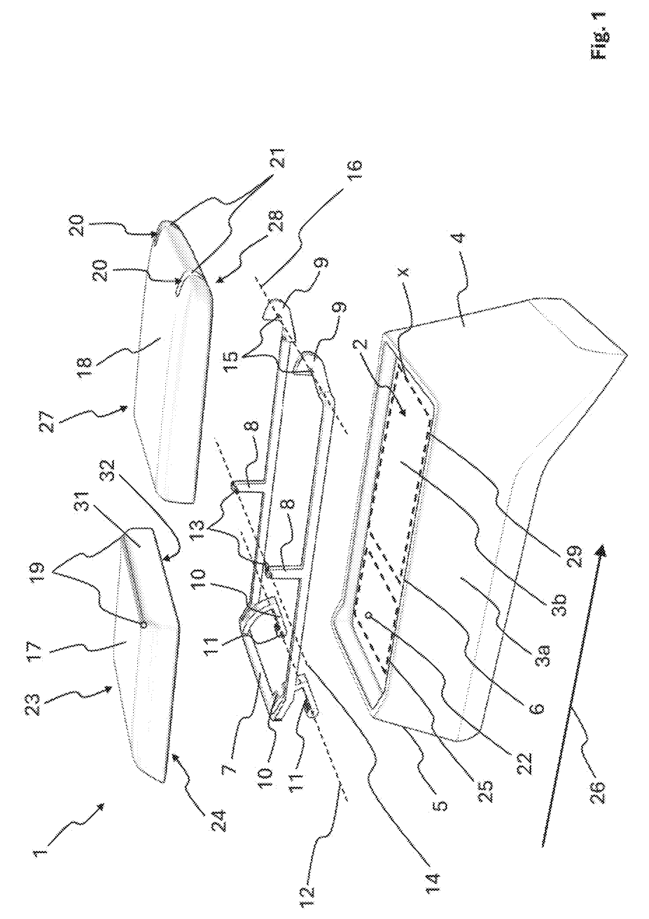

FIG. 1 is an upper exploded perspective view of an intermediate seat armrest, according to one embodiment;

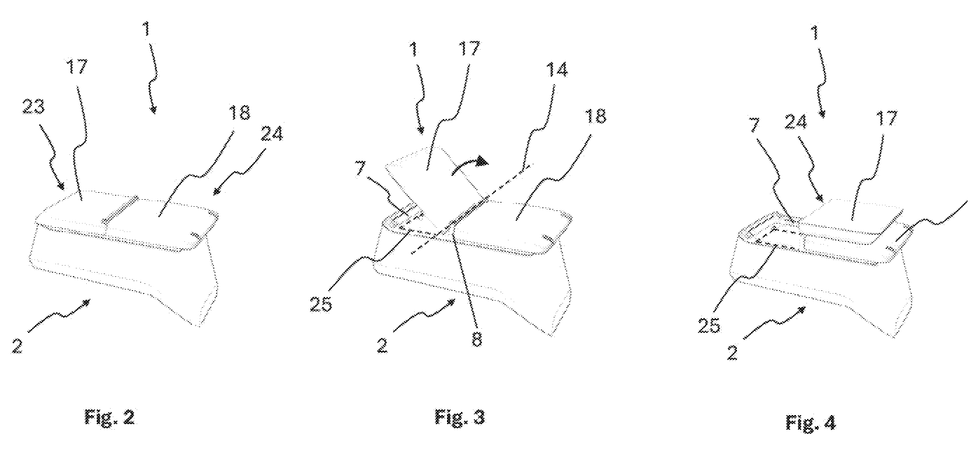

FIG. 2 is an upper perspective view of the intermediate seat armrest of FIG. 1 in an assembled state;

FIG. 3 is an upper perspective view of the intermediate seat armrest of FIG. 1 when pivoting the first pivotable closure cover part;

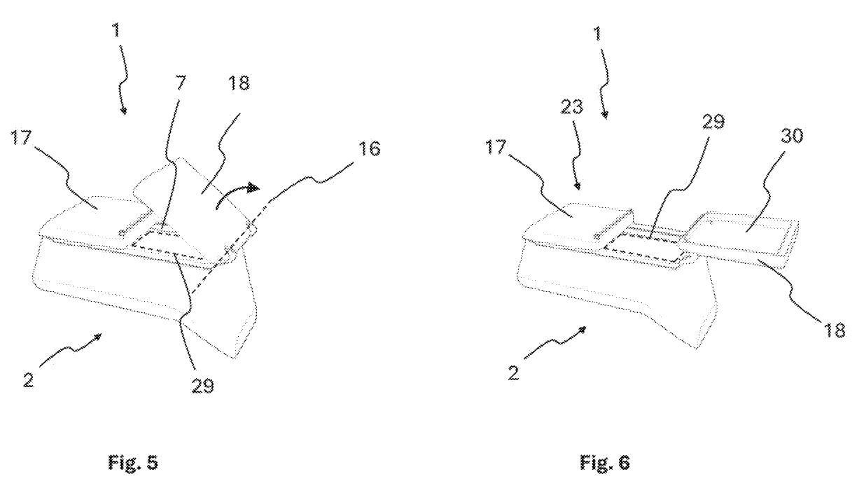

FIG. 4 is an upper perspective view of the intermediate seat armrest of FIG. 1 with the first pivotable closure cover part in the open position;

FIG. 5 is an upper perspective view of the intermediate seat armrest of FIG. 1 when pivoting the second pivotable closure cover part;

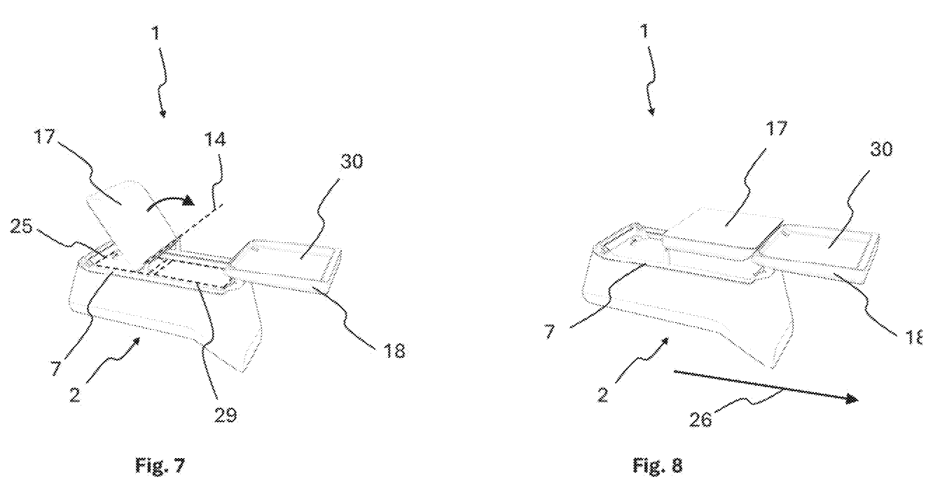

FIG. 6 is an upper perspective view of the intermediate seat armrest of FIG. 1 with the second pivotable closure cover part in the open position;

FIG. 7 is an upper perspective view of the intermediate seat armrest of FIG. 1 when pivoting the first pivotable closure cover part, wherein the second pivotable closure cover part is in the open position;

FIG. 8 is an upper perspective view of the intermediate seat armrest, wherein the first pivotable closure cover part and the second pivotable closure cover part are shown in their respective open positions; and

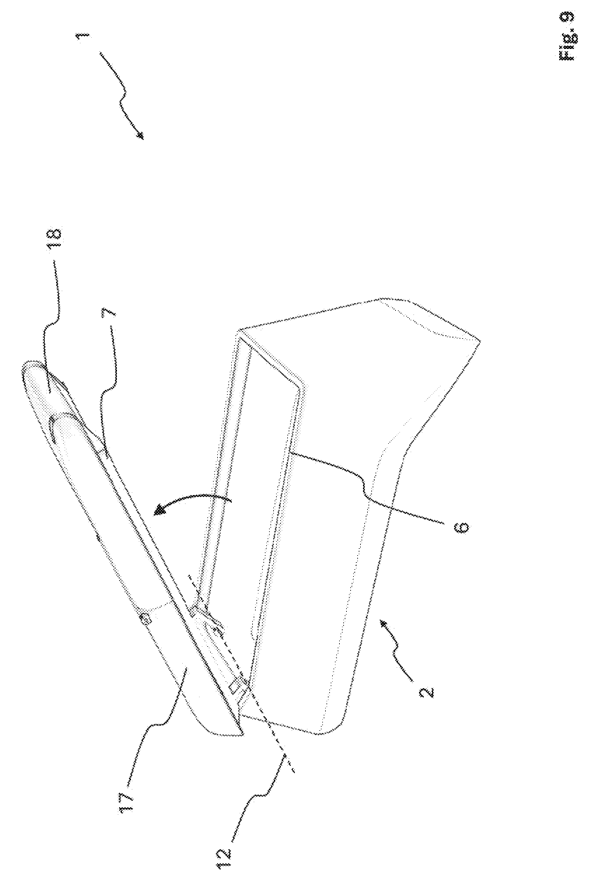

FIG. 9 is an upper perspective view of the intermediate seat armrest, wherein the pivotable carrier is pivoted about the first axis of rotation.

### DETAILED DESCRIPTION OF PREFERRED EMBODIMENTS

The same parts are always provided with the same reference signs in the various figures, which is why generally they are only described once. The terms “first”, “second”, etc. used below and above serve merely for the purpose of differentiation. In particular, no sequence or priority of the objects mentioned in connection with these terms is intended to be implied by the use thereof.

FIG. 1 shows the intermediate seat armrest 1 for a motor vehicle, according to one embodiment, with its constituent parts in a view separated into its individual parts, also denoted as an exploded view. The intermediate seat armrest 1 may serve as a center console located between two seats in the motor vehicle.

The intermediate seat armrest 1 comprises the substantially hollow cuboidal storage compartment 2. The storage compartment 2 is formed by the base, not shown, two side walls 3a and 3b, which are arranged approximately parallel to one another, the front wall 4 and the rear wall 5. A rectangular opening 6 is configured in the upper region of the upwardly open storage compartment 2.

A pivotable carrier 7 above this storage compartment 2 is shown in FIG. 1. The pivotable carrier 7, when viewed from above, is designed to be U-shaped. First tabs 8 and second tabs 9 are oriented in each case upwardly and arranged opposingly in the region of the arms of the U-shaped pivotable carrier 7 running in parallel. Two downwardly oriented retaining arms 10 are arranged in the region of a curved base of the U-shaped pivotable carrier 7.

First cylindrical journals 11 are configured on the ends of these retaining arms 10. A first axis of rotation 12 runs through the respective longitudinal axes of these first cylindrical journals 11 opposingly arranged on the retaining arms 10.

Second cylindrical journals 13 are configured on the ends of the first tabs 8. A second axis of rotation 14 runs through the respective longitudinal axes of the second cylindrical journals 13 opposingly arranged on the first tabs 8.

Third cylindrical journals 15 are configured on the ends of the second tabs 9. A third axis of rotation 16 runs through the respective longitudinal axes of the third cylindrical journals 15 opposingly arranged on the second tabs 9.

When viewed in the drawing plane of FIG. 1, at the left, a first pivotable closure cover part 17 and, at the right, a second pivotable closure cover part 18 are shown above the pivotable carrier 7. In an assembled state of the intermediate seat armrest 1, the first pivotable closure cover part 17 is arranged on the pivotable carrier 7 so as to be pivotable about the second axis of rotation 14. The second cylindrical journals 13 which are received so as to be rotatably mounted in a second cylindrical receiver 19 on the front face on the first pivotable closure cover part 17 are used for this pivotable arrangement of the first pivotable closure cover part 17. To this end, in an advantageous embodiment, the first tabs 8 are designed to be adapted to a thickness of the first closure cover part 17, so that the second cylindrical journals 13 can engage in the second cylindrical receiver 19. In an ideal embodiment, the first tabs 8 are able to be resiliently deflected so that the second cylindrical journals 13 on the respective side of the receiver 19 can be easily brought into engagement therewith. The second axis of rotation 14 is expediently arranged on the upper tangent point of the first and second closure cover part 17 and 18, resulting in the required height of the first tabs 8 and the arrangement of the second cylindrical receiver 19. In the exemplary embodiment shown, the tabs 8 are arranged laterally adjacent to the first closure cover part 17 and in the embodiment shown in the visible region, which is not disadvantageous however. The first tabs 8 are not shown in FIGS. 2, 5 and 6. A front end 31 of the first closure cover part 17 otherwise has an edge 32 oriented in the direction of the carrier 7.

In the exemplary embodiment shown, the second cylindrical receiver 19 is arranged continuously on the front end 31 of the first closure cover part 17. An embodiment is also conceivable in which two cylindrical receivers which are separate from one another are arranged in each case laterally on the front end 31 of the first closure cover part 17, with a cylindrical receiver for each of the second cylindrical journals 13.

In the exemplary embodiment shown, the first tabs 8 are arranged externally. An embodiment is conceivable in which the first tabs 8 are arranged internally, such that they are not visible in the basic position of the two closure cover parts 17 and 18, wherein telescopic pivot joints can be provided between the first closure cover part 17 and the carrier 7, preferably on the first tabs 8, so that a pivoting movement of the first closure cover part 17 out of the basic position and back again might be possible without being impeded.

In an assembled state of the intermediate seat armrest 1, the second pivotable closure cover part 18 is arranged on the pivotable carrier 7 so as to be pivotable about the third axis of rotation 16. The third cylindrical journals 15 which are received so as to be rotatably mounted in third cylindrical recesses 20 or receivers on the end of the second pivotable closure cover part 18 are used for this pivotable arrangement of the second pivotable closure cover part 18. These third cylindrical recesses 20 are located in the region of cutouts 21 of the second pivotable closure cover part 18 and thus cannot be identified in more detail in FIG. 1.

In an assembled state of the intermediate seat armrest 1, the pivotable carrier 7 is arranged on the storage compartment 2 so as to be pivotable about the first axis of rotation 12. The first cylindrical journals 11, which are received so as to be rotatably mounted in first cylindrical recesses 22, are used for this pivotable arrangement of the pivotable carrier 7. These first cylindrical recesses 22 are arranged in the interior of the storage compartment 2, whereby in FIG. 1 only one of these first cylindrical recesses 22 can be identified.

The first pivotable closure cover part 17 has a first upper face 23 and a first lower face 24. The first pivotable closure cover part 17 is shown in FIG. 1 oriented in its basic position in which the first pivotable closure cover part 17 closes a first partial opening 25 of the rectangular opening 6 in an assembled state of the intermediate seat armrest 1. If the first pivotable closure cover part 17 is pivoted about the second axis of rotation 14 in the direction of its open position, the first partial opening 25 is opened up so that access to the storage compartment 2 is made possible, in particular to persons in the rear region of the motor vehicle. The open position of the first pivotable closure cover part 17 is not shown in FIG. 1. In order to clarify the installed position of the intermediate seat armrest 1 in the motor vehicle, a forward direction of travel 26 is illustrated in FIG. 1. The first pivotable closure cover part 17 is accordingly arranged to the rear of the second pivotable closure cover part 18 which is arranged at the front, when viewed in the forward direction of travel 26.

The first upper face 23 and the first lower face 24 are in each case upholstered surfaces. Thus both the first upper face 23 can be used in the basic position of the first pivotable closure cover part 17 and the first lower face 24 can be used in the open position of the first pivotable closure cover part 17 as a comfortable support surface for the arm of the driver. In the open position of the first pivotable closure cover part 17 the first lower face 24 is at a height which is above the height of the first upper face 23 when the first pivotable closure cover part 17 is in its basic position. The height difference is determined by a thickness of the first pivotable closure cover part 17, which corresponds to the distance between the first upper face 23 and the first lower face 24.

The second pivotable closure cover part 18 has a second upper face 27 and a second lower face 28. The second pivotable closure cover part 18 is shown in FIG. 1 oriented in its basic position in which the second pivotable closure cover part 18 closes a second partial opening 29 of the rectangular opening 6 in an assembled state of the intermediate seat armrest 1. If the second pivotable closure cover part 18 is pivoted about the third axis of rotation 16 in the direction of its open position, the second partial opening 29 is opened up so that access to the storage compartment 2 is made possible, in particular, to persons in the front region of the motor vehicle. The open position of the second pivotable closure cover part 18 is not shown in FIG. 1.

The second upper face 27 is an upholstered surface. Thus the second upper face 27 can be used as a comfortable support surface for the arm of the driver. It is further provided that the second lower face 28 of the second pivotable closure cover part 18 is configured as a tray-shaped support 30. In order to be able to use this tray-shaped support 30 of the second pivotable closure cover part 18, the second pivotable closure cover part 18 is brought into its substantially horizontal open position in which it is arranged so as to protrude from the intermediate seat armrest 1 in the direction of travel 26. The open position of the second pivotable closure cover part 18, in which the tray-shaped support 30 might be identified, is not shown in FIG. 1.

Expediently, the two closure cover parts 17 and 18 are pivotable independently of one another and relative to one another via their respective axis of rotation 14 and 16.

The intermediate seat armrest 1 is shown in an assembled state in FIG. 2. The first pivotable closure cover part 17 and the second pivotable closure cover part 18 are arranged so as to be oriented in the respective basic positions on the substantially hollow cuboidal storage compartment 2. In these basic positions, the closure cover parts 17 and 18 are positioned in each case so as to bear against the pivotable carrier 7. In this manner, the first pivotable closure cover part 17 closes the first partial opening 25, not shown, while the second pivotable closure cover part 18 closes the second partial opening 29, not shown.

The first upper face 23 and the second upper face 27 are designed to be upholstered and in this manner provide a support surface, for example for an arm of the driver of the motor vehicle, in a first vertical position.

In the view of FIG. 2, the pivotable carrier 7, which also cannot be identified, is also arranged so as to be oriented in its basic position in the storage compartment 2.

FIG. 3 shows the intermediate seat armrest 1 during a pivoting of the first pivotable closure cover part 17 in the direction shown by an arrow. The first pivotable closure cover part 17 is pivoted about the second axis of rotation 14, wherein the first partial opening 25 is partially opened up.

The second pivotable closure cover part 18 and the pivotable carrier 7 are in their respective basic positions in the view of FIG. 3.

The intermediate seat armrest 1 with the first pivotable closure cover part 17, which is in the open position, is shown in FIG. 4. After the first pivotable closure cover part 17 is pivoted out of its basic position by approximately 180 degrees, the first pivotable closure cover part 17 reaches its open position as shown in FIG. 4. Now the first partial opening 25 is fully opened up.

In this open position, the first pivotable closure cover part 17 is arranged above the second pivotable closure cover part 18 which is in its basic position. The first upper face 23 of the first pivotable closure cover part 17 is arranged so as to be positioned on the second upper face 27 of the second pivotable closure cover part 18. The first lower face 24 of the first pivotable closure cover part 17, which is designed to be upholstered, faces upwardly. In this manner, a support surface, for example for an arm of the driver of the motor vehicle, is provided in a second vertical position on the first lower face 24. A height difference between the first vertical position and the second vertical position can be identified by a comparison of FIGS. 2 and 4. The height difference between both vertical positions is substantially determined by a thickness of the first pivotable closure cover part 17.

FIG. 5 shows the intermediate seat armrest 1 during a pivoting of the second pivotable closure cover part 18 in the direction shown by an arrow. The second pivotable closure cover part 18 is pivoted about the third axis of rotation 16, wherein the second partial opening 29 is partially opened up.

The first pivotable closure cover part 17 and the pivotable carrier 7 are in their respective basic positions in the view of FIG. 5.

The intermediate seat armrest 1 is shown in FIG. 6 with the second pivotable closure cover part 18 in the open position. After the second pivotable closure cover part 18 has been pivoted out of its basic position by approximately 180 degrees, the second pivotable closure cover part 18 reaches its open position, as shown in FIG. 6. The second partial opening 29 is now fully opened up.

In this open position, the second pivotable closure cover part 18 is arranged so as to protrude from the intermediate seat armrest 1 in the direction of travel 26. The second lower face 28 of the second pivotable closure cover part 18, which is designed as a tray-shaped support 30, faces upwardly. In this manner, an additional option is provided for the support of objects in the motor vehicle.

The first pivotable closure cover part 17 is shown in the example of FIG. 6 in its basic position and provides on its first upper face 23 a support surface for the arm of the driver of the motor vehicle in the first vertical position.

FIG. 7 shows the intermediate seat armrest 1 during a pivoting of the first pivotable closure cover part 17, wherein the second pivotable closure cover part 18 is in its open position.

Moreover, in the case that the second pivotable closure cover part 18 has already been moved into its open position and in this manner the second partial opening 29 is accessible, the first pivotable closure cover part 17 can be pivoted from its basic position about the second axis of rotation 14 in order to open up the first partial opening 25. In the example of FIG. 7, the pivotable carrier 7 is arranged in its basic position on the rectangular opening 6 of the intermediate seat armrest 1.

FIG. 8 shows the intermediate seat armrest 1, wherein the first pivotable closure cover part 17 and the second pivotable closure cover part 18 are shown in their respective open positions.

In this manner, on the one hand, the tray-shaped support 30 of the second pivotable closure cover part 18 can be used as a support, while on the other hand a support surface for the arm of the driver of the motor vehicle is provided by the first pivotable closure cover part 17 in the second vertical position. As can be identified in FIG. 8, the first pivotable closure cover part 17 with its previously rear edge, which is designed to be beveled, is visibly supported on a previously front edge of the second pivotable closure cover part 18, so that the armrest function is still provided. It can also be identified that an easy access to the first partial opening 25 is provided for the passengers of the vehicle rear during this pivoting of the two closure cover parts 17 and 18 relative to one another.

FIG. 9 shows the intermediate seat armrest 1, wherein the pivotable carrier 7 is pivoted about the first axis of rotation 12. In this manner, the entire rectangular opening 6 of the storage compartment 2, comprising the first partial opening 25 and the second partial opening 29, is opened up.

The pivotable carrier 7 can be pivoted about the first axis of rotation 12 in the direction shown by the arrow. In the example of FIG. 9, the first pivotable closure cover part 17 and the second pivotable closure cover part 18 are positioned in the respective basic positions so as to bear against the pivotable carrier 7.

The pivotable carrier 7 can be pivoted about the first axis of rotation 12 in the direction shown by the arrow, even in the case that the first pivotable closure cover part 17 is in its open position or when the second pivotable closure cover part 18 is in its open position. In addition, the pivotable carrier 7 can be pivoted about the first axis of rotation 12, even in the case that both pivotable closure cover parts 17 and 18 are in the respective open positions. These options are not shown in FIG. 9.

The intermediate seat armrest for a motor vehicle provides, in addition to a storage space, the comfort of height adjustment. In addition, a further storage option for the occupants of the motor vehicle and an accessibility to the storage compartment both from the front seats of the motor vehicle and from the rear seats are intended to be provided.

The intermediate seat armrest for a motor vehicle has at least one substantially hollow cuboidal storage compartment and a closure cover covering the hollow cuboidal storage compartment. The pivotable carrier is arranged on the hollow cuboidal storage compartment, wherein a first pivotable closure cover part and a second pivotable closure cover part, which jointly form the entire closure cover, are arranged on the pivotable carrier.

It should be mentioned that the features and measures set forth individually in the following description can be combined with one another in any technically expedient manner and illustrate further embodiments of the disclosure. The description characterizes and specifies the disclosure, in particular additionally in connection with the figures. The terms “first”, “second”, etc. used below and above serve merely for the purpose of differentiation. In particular, no sequence or priority of the objects mentioned in connection with these terms is intended to be implied by the use thereof.

An intermediate seat armrest for a motor vehicle is provided by the disclosure. The term “motor vehicle” refers in the narrower sense to a road vehicle, i.e. a vehicle with a separate drive motor which is suitable and permitted for road transport. The drive motor can be an internal combustion engine, an electric motor or a hybrid drive comprising an internal combustion engine. In particular, it can be a passenger motor vehicle, a utility vehicle or a bus. Preferably, the motor vehicle has at least two axles with in each case two wheels, but deviations therefrom are also conceivable. The motor vehicle can be controllable at least temporarily by a driver. However, it can also be designed to travel at least temporarily autonomously, i.e. without being controlled by a driver.

The intermediate seat armrest for the motor vehicle has a substantially hollow cuboidal storage compartment. Such a hollow cuboidal storage compartment or such a hollow space is formed by a base and four lateral walls, wherein the hollow cuboidal storage compartment has an upwardly oriented opening. The four lateral walls are, for example, two side walls which are arranged approximately parallel to one another and which extend vertically and in a direction of travel of the motor vehicle, and a front wall and a rear wall which are also arranged approximately parallel to one another and vertically and transversely to the direction of travel of the motor vehicle. The side walls are substantially longer than the front wall or the rear wall of the hollow cuboidal storage compartment. The wall of the hollow cuboidal storage compartment which is arranged on the hollow cuboidal storage compartment so as to be oriented in the direction of travel of the motor vehicle is denoted as the front wall. The wall of the hollow cuboidal storage compartment which is arranged on the hollow cuboidal storage compartment opposing the direction of travel of the motor vehicle is denoted as the rear wall.

Any objects, such as for example keys, mobile phones, adapter cables, drinks, snacks or other objects which are required during a journey in the motor vehicle and which have a restricted size can be introduced into the storage compartment or removed therefrom via the opening of the hollow cuboidal storage compartment. These objects are reliably stowed in the storage compartment and even in the case of extreme driving situations cannot enter the passenger compartment of the motor vehicle in a disruptive manner.

For completing the intermediate seat armrest, it has a closure cover which covers the hollow cuboidal storage compartment. This closure cover is preferably designed with upholstery on its upper face, so that the comfort is also increased over a lengthy period of time by assisting the support of a lower arm.

Generally, the closure cover is pivotably fastened to the hollow cuboidal storage compartment, so that when the closure cover is opened, access to the hollow cuboidal storage compartment is generally made possible counter to the direction of travel of the motor vehicle.

The expression that the storage compartment is designed to be substantially hollow cuboidal illustrates that deviations, for example by oblique walls or deviations from a strictly angular design, still fall within the protected scope of the disclosure, since the intermediate seat armrests are adapted to the interior design of the motor vehicle.

According to the disclosure, a pivotable carrier is arranged on the hollow cuboidal storage compartment to be pivotable about a first axis of rotation is arranged on the hollow cuboidal storage compartment. A first pivotable closure cover part is arranged on the pivotable carrier, wherein the first pivotable closure cover part is pivotable relative to the pivotable carrier. In addition, a second pivotable closure cover part is also pivotable relative to the pivotable carrier and arranged on the pivotable carrier. The first pivotable closure cover part and the second pivotable closure cover part form the entire two-part closure cover in their respective basic positions in which the closure cover parts are arranged in each case so as to bear against the pivotable carrier. This two-part closure cover is designed to cover or to close completely the hollow cuboidal storage compartment of the intermediate seat armrest.

In the case that the hollow cuboidal storage compartment of the intermediate seat armrest is closed by the two-part closure cover in a manner in which it is covered, both the closure cover parts and the pivotable carrier are arranged so as to be substantially horizontally oriented in the region of the opening of the hollow cuboidal storage compartment.

In the case that the hollow cuboidal storage compartment of the intermediate seat armrest is closed by the two-part closure cover in a manner in which it is covered, the pivotable carrier is in its basic position on the opening of the hollow cuboidal storage compartment. Moreover, both the first pivotable closure cover part and the second pivotable closure cover part are arranged so as to be oriented in the respective basic positions on the pivotable carrier.

In one embodiment, the pivotable carrier is arranged on the hollow cuboidal storage compartment so as to be pivotable about a first axis of rotation.

It is provided that the pivotable carrier is arranged on the hollow cuboidal storage compartment so as to be pivotable about a first axis of rotation and in this manner can open up an opening of the hollow cuboidal storage compartment arranged at the top on the hollow cuboidal storage compartment, by a pivoting movement such as opening. During this pivoting movement of the pivotable carrier when the storage compartment is opened, the first pivotable closure cover part which is arranged on this pivotable carrier and the second pivotable closure cover part are moved or pivoted therewith. During this pivoting movement, the first pivotable closure cover part and the second pivotable closure cover part remain in their respective basic positions on the pivotable carrier in which the closure cover parts are arranged in each case so as to bear against the pivotable carrier.

The first axis of rotation is preferably arranged in a region of the rear wall of the hollow cuboidal storage compartment and in the vicinity of the upwardly oriented opening of the hollow cuboidal storage compartment. Downwardly oriented retaining arms may be arranged on the pivotable carrier, first cylindrical journals being configured on the ends thereof. These first cylindrical journals are received in the region of the first axis of rotation by corresponding first receivers incorporated on the inner faces of the side walls, such as first cylindrical recesses. When the first cylindrical journals are rotatably mounted in the first cylindrical recesses, the pivotable carrier can be moved or pivoted relative to the hollow cuboidal storage compartment. Such a cylindrical journal is also denoted as a cylindrical pin. Such a cylindrical recess is designed to be comparable with a counterbore.

In a further embodiment of the intermediate seat armrest, the first pivotable closure cover part may be arranged on the pivotable carrier to be pivotable about a second axis of rotation.

The first pivotable closure cover part can be pivoted from its basic position, in which the first pivotable closure cover part is arranged so as to bear against the pivotable carrier, away from the pivotable carrier about the second axis of rotation. If the pivotable carrier is in its basic position on the opening of the hollow cuboidal storage compartment, when the first pivotable closure cover part is pivoted away, a first partial opening of the hollow cuboidal storage compartment is opened up in the region of the first pivotable closure cover part. In particular, the first pivotable closure cover part is pivoted or opened in the direction of travel and opens up the first partial opening such that it is accessible to persons in the rear region of the motor vehicle who are positioned on a rear seat bench of the motor vehicle.

The pivoting of the first pivotable closure cover part in the direction of travel about the second axis of rotation can take place to a maximum extent, such that the first pivotable closure cover part is pivoted about an angle of approximately 180 degrees. Thus the first pivotable closure cover part bearing against the pivotable carrier in its basic position is moved into a position which is denoted as the open position of the first pivotable closure cover part. In this open position the first pivotable closure cover part is arranged parallel to the second pivotable closure cover part and above the second pivotable closure cover part, with the provison that the second pivotable closure cover part is arranged so as to be oriented in its basic position on the pivotable carrier. In this open position of the first pivotable closure cover part, a first upper face of the first pivotable closure cover part is positioned so as to bear against a second upper face of the second pivotable closure cover part. A first lower face of the first pivotable closure cover part faces upwardly in its open position.

Moreover, in the case that the first pivotable closure cover part is in its open position and the second pivotable closure cover part is in its basic position, the pivotable carrier can be pivoted about its first axis of rotation.

The second axis of rotation is preferably arranged, for example, in a central region of the pivotable carrier. Preferably, first upwardly oriented tabs are configured on the pivotable carrier, second cylindrical journals being configured thereon. These second cylindrical journals are received in the region of the second axis of rotation by a corresponding second cylindrical receiver arranged on the first pivotable closure cover part. Since the second cylindrical journals are rotatably mounted in the second cylindrical receiver, the first pivotable closure cover part can be moved or pivoted relative to the pivotable carrier.

In an additional embodiment, the second pivotable closure cover part may be arranged on the pivotable carrier so as to be pivotable about a third axis of rotation.

The second pivotable closure cover part can be pivoted from its basic position, in which the second pivotable closure cover part is arranged so as to bear against the pivotable carrier, away from the pivotable carrier about the third axis of rotation. If the pivotable carrier is in its basic position on the opening of the hollow cuboidal storage compartment, when the second pivotable closure cover part is pivoted away, a second partial opening of the hollow cuboidal storage compartment is opened up in the region of the second pivotable closure cover part. In particular, the second pivotable closure cover part is pivoted or opened in the direction of travel and opens up the second partial opening such that it is accessible to persons in the front region of the motor vehicle, i.e. to the driver or the front passenger.

The pivoting of the second pivotable closure cover part in the direction of travel about the third axis of rotation can take place to a maximum extent, such that the second pivotable closure cover part is pivoted by an angle of approximately 180 degrees. Thus the second pivotable closure cover part bearing against the pivotable carrier in its basic position is moved into a position which is denoted as the open position of the second pivotable closure cover part. In this open position, the second pivotable closure cover part is oriented such that it is arranged so as to protrude from the intermediate seat armrest in the direction of travel.

In the case that the pivotable carrier is in its basic position, the second pivotable closure cover part is arranged so as to protrude horizontally from the intermediate seat armrest such that a second lower face of the second pivotable closure cover part is oriented upwardly and a second upper face of the second pivotable closure cover part is oriented downwardly.

Moreover, in the case that the second pivotable closure cover part is in its open position, the pivotable carrier can be pivoted about its first axis of rotation. Moreover, in the case that the second pivotable closure cover part is in its open position, the first pivotable closure cover part can be pivoted as required between its basic position and its open position.

The third axis of rotation is preferably arranged in a front region of the pivotable carrier facing in the direction of travel. Preferably, second upwardly oriented tabs are configured on the pivotable carrier, third cylindrical journals being configured thereon. These third cylindrical journals are received in the region of the third axis of rotation by corresponding third receivers incorporated in the second pivotable closure cover part, such as third cylindrical recesses. When the third cylindrical journals are rotatably mounted in the third cylindrical recesses, the second pivotable closure cover part can be moved or pivoted relative to the pivotable carrier.

Since both the first pivotable closure cover part and the second pivotable closure cover part can be pivoted separately about their respective axis of rotation on the pivotable carrier, it is possible to open up the first partial opening or the second partial opening or both partial openings or to open the partial openings independently of one another.

In a particular embodiment, it is provided that in each case a first upholstered surface is arranged on a first upper face of the first pivotable closure cover part and on a second upper face of the second pivotable closure cover part.

In order to design the two-part closure cover covering the hollow cuboidal storage compartment in a comfortable manner, upholstered surfaces are arranged in each case so as to be applied to the first upper face of the first pivotable closure cover part and to the second upper face of the second pivotable closure cover part. Thus, in the case that the storage compartment is completely closed by the two-part closure cover, an entire upper face of the two-part closure cover comprising the first upper face and the second upper face forms a flat upholstered surface on which the driver of the motor vehicle can comfortably rest their lower arm over a lengthy period of time.

In one embodiment, it is provided that a second upholstered surface is arranged on a first lower face of the first pivotable closure cover part.

The first pivotable closure cover part can be pivoted about the second axis of rotation from its basic position into its open position. Thus a first lower face of the first pivotable closure cover part faces upwardly. Expediently, a second upholstered surface is arranged on the first lower face of the first pivotable closure cover part. In this manner, the first lower face of the first pivotable closure cover part can be used for comfortably resting the lower arm of the driver of the motor vehicle. An advantage of this variant is in providing a changeable vertical position of the intermediate seat armrest for the driver. A second vertical position or a height adjustment of the intermediate seat armrest is provided by pivoting the first pivotable closure cover part from its basic position by approximately 180 degrees into the open position. The comfort of height adjustment for different heights of drivers of the motor vehicle is implemented in this manner.

In a further embodiment of the intermediate seat armrest, a second lower face of the second pivotable closure cover part is configured as a tray-shaped support.

The intermediate seat armrest according to the disclosure provides an additional support option. To this end, the second pivotable closure cover part is pivoted into its open position in the region in front of the intermediate seat armrest. For implementing the support option according to the disclosure, the second lower face of the second pivotable closure cover part is configured in a tray-shaped or trough-shaped manner and is arranged upwardly oriented in the open position. The term tray-shaped means that the second lower face of the second pivotable closure cover part is designed to be surrounded by an edge or to be substantially convex, so that objects arranged on this support are retained at least to a limited extent in the region of the tray-shaped support.

In particular, it can be provided that the second pivotable closure cover part has cutouts, second tabs of the pivotable carrier being arranged so as to be engaged therein.

For the pivotable fastening of the second pivotable closure cover part to the upwardly oriented second tabs of the pivotable carrier, vertical cutouts are arranged in the front region of the second pivotable closure cover part in its basic position. The second tabs of the pivotable carrier are received in the region of these cutouts such that the second pivotable closure cover part forms with the second tabs a common, preferably rounded, outer contour. The third axis of rotation is located in this region with the third cylindrical journals, not visible from the outside, and the third cylindrical recesses for implementing the pivoting function of the second pivotable closure cover part.

It may also be provided that the first axis of rotation, the second axis of rotation and the third axis of rotation are arranged so as to be oriented parallel to one another.

The three axes of rotation of the intermediate seat armrest are oriented parallel to one another, in order to ensure the above-described options when pivoting the pivotable carrier, the first pivotable closure cover part and the second pivotable closure cover part.

It may be provided that the axes of rotation are arranged so as to be oriented in the direction of a transverse axis of the motor vehicle at right-angles to a forward or rearward direction of travel of the motor vehicle.

The three parallel axes of rotation may be arranged so as to be oriented in a transverse direction of the motor vehicle and thus at right-angles to a longitudinal direction of the motor vehicle or the direction of travel of the motor vehicle. In addition, the orientation of the three parallel axes of rotation is advantageously horizontal.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An intermediate seat armrest for a motor vehicle, the intermediate seat armrest comprising:
at least one substantially hollow cuboidal storage compartment;
a closure cover covering the hollow cuboidal storage compartment; and
a pivotable carrier arranged on the hollow cuboidal storage compartment, wherein a first pivotable closure cover part and a second pivotable closure cover part jointly form the entire closure cover and are arranged on the pivotable carrier.

2. The intermediate seat armrest according to claim 1, wherein the pivotable carrier is arranged on the hollow cuboidal storage compartment to be pivotable about a first axis of rotation.

3. The intermediate seat armrest according to claim 2, wherein the first pivotable closure cover part is arranged on the pivotable carrier to be pivotable about a second axis of rotation.

4. The intermediate seat armrest according to claim 3, wherein the second pivotable closure cover part is arranged on the pivotable carrier to be pivotable about a third axis of rotation.

5. The intermediate seat armrest according to claim 1, further comprising a first upholstered surface arranged on a first upper face of the first pivotable closure cover part and on a second upper face of the second pivotable closure cover part.

6. The intermediate seat armrest according to claim 5, further comprising a second upholstered surface arranged on a first lower face of the first pivotable closure cover part.

7. The intermediate seat armrest according to claim 6, further comprising a second lower face of the second pivotable closure cover part configured as a tray-shaped support.

8. The intermediate seat armrest according to claim 1, wherein the second pivotable closure cover part has cutouts, and wherein tabs of the pivotable carrier are arranged to be engaged in the cutouts.

9. The intermediate seat armrest according to claim 4, wherein the first axis of rotation, the second axis of rotation and the third axis of rotation are arranged to be oriented parallel to one another.

10. The intermediate seat armrest according to claim 9, wherein the first axis of rotation, the second axis of rotation and the third axis of rotation are arranged to be oriented in a direction of a transverse axis of the motor vehicle at right-angles to a direction of travel of the motor vehicle.

11. A seat armrest for a motor vehicle, the seat armrest comprising:
at least one substantially hollow cuboidal storage compartment;
a closure cover covering the hollow cuboidal storage compartment; and
a pivotable carrier arranged on the hollow cuboidal storage compartment, wherein a first pivotable closure cover part and a second pivotable closure cover part jointly form the entire closure cover and are arranged on the pivotable carrier, wherein the pivotable carrier is arranged on the hollow cuboidal storage compartment to be pivotable about a first axis of rotation, wherein the first pivotable closure cover part is arranged on the pivotable carrier to be pivotable about a second axis of rotation, wherein the second pivotable closure cover part is arranged on the pivotable carrier to be pivotable about a third axis of rotation, and wherein the first axis of rotation, the second axis of rotation and the third axis of rotation are arranged to be oriented parallel to one another.

12. The seat armrest according to claim 11, further comprising a first upholstered surface arranged on a first upper face of the first pivotable closure cover part and on a second upper face of the second pivotable closure cover part.

13. The seat armrest according to claim 12, further comprising a second upholstered surface arranged on a first lower face of the first pivotable closure cover part.

14. The seat armrest according to claim 13, further comprising a second lower face of the second pivotable closure cover part configured as a tray-shaped support.

15. The seat armrest according to claim 11, wherein the second pivotable closure cover part has cutouts, and wherein tabs of the pivotable carrier are arranged to be engaged in the cutouts.

16. The seat armrest according to claim 11, wherein the first axis of rotation, the second axis of rotation and the third axis of rotation are arranged to be oriented in a direction of a transverse axis of the motor vehicle at right-angles to a direction of travel of the motor vehicle.

17. The seat armrest according to claim 11, wherein the seat armrest is an intermediate seat armrest for use between two seats in the motor vehicle.
